(19) United States
(12) Patent Application Publication
(10) Pub. No.: US 2006/0156885 A1
(43) Pub. Date: Jul. 20, 2006

(54) Cutter assembly of paper cutting device

(76) Inventor: Michael Y.M. Wu, Taipei (TW)

Correspondence Address: BACON & THOMAS, PLLC, 625 SLATERS LANE, FOURTH FLOOR, ALEXANDRIA, VA, 22314, US

(21) Appl. No.: 11/037,171

(22) Filed: Jan. 19, 2005

(51) Int. Cl. B26D 1/18

(52) U.S. Cl. 83/485; 83/614

(57) ABSTRACT

A paper cutting device has a board, a rail mounted on the board and a cutter assembly provided on the rail for reciprocation along the rail. The cutter assembly has a housing. A base is fixed at a bottom of the housing, which has a first slot and a second slot. A first cutter is received in the first slot of the base to be moved between an extruding position and a storage position. A second cutter is received in the second slot of the base to be moved between an extruding position and a storage position. A switch is received in the housing to be moved between the a first position, in which the switch moves the first cutter to the extruding position, and a second position, in which the switch moves the second cutter to the extruding position.

### BACKGROUND OF THE INVENTION

1. Field of the Invention

The present invention relates generally to a paper cutting device, and more particularly to a paper cutting device, which provides various patterns of cutting.

2. Description of the Related Art

A conventional paper cutting device is put on a table or desk to cut papers, which has a base with a rail and a cutter assembly slidably mounted on the rail of the base. The cutter assembly has a cutter and is reciprocated along the rail to cut the paper on the base. Such paper cutting device has a simple structure and single function that is broadly applied to user because of its convenience.

### SUMMARY OF THE INVENTION

The primary objective of the present invention is to provide a cutter assembly of a paper cutting device, which have various cutting patterns for choice as well as simple structure and easy operation.

According to the objective of the present invention, a cutter assembly of a paper cutting device comprises a housing having a chamber therein. A base is fixed at a bottom of the housing, which has a first slot and a second slot, and both of the slots are communicated with the chamber of the housing. A first cutter is received in the first slot of the base to be moved between an extruding position and a storage position. A second cutter is received in the second slot of the base to be moved between an extruding position and a storage position. A switch is received in the chamber of the housing to cover the first cutter and the second cutter. The switch is moved between the a first position, in which the switch moves the first cutter to the extruding position from the storage position, and a second position, in which the switch moves the second cutter to the extruding position from the storage position.

### BRIEF DESCRIPTION OF THE DRAWINGS

FIG. 1 is a perspective view of a preferred embodiment of the present invention;

FIG. 2 is an exploded view of the preferred embodiment of the present invention;

FIG. 3 is a sectional view of the cutter assembly of the preferred embodiment of the present invention;

FIG. 4 is a sectional view of the cutter assembly of the preferred embodiment of the present invention, showing the cutter when the switch is moved to the first position;

FIG. 5 is a sectional view of the cutter assembly of the preferred embodiment of the present invention, showing the rolling cutter when the switch is moved to the first position;

FIG. 6 is a sectional view of the cutter assembly of the preferred embodiment of the present invention, showing the cutter when the switch is moved to the second position, and

FIG. 7 is a sectional view of the cutter assembly of the preferred embodiment of the present invention, showing the rolling cutter when the switch is moved to the second position.

### DETAILED DESCRIPTION OF THE INVENTION

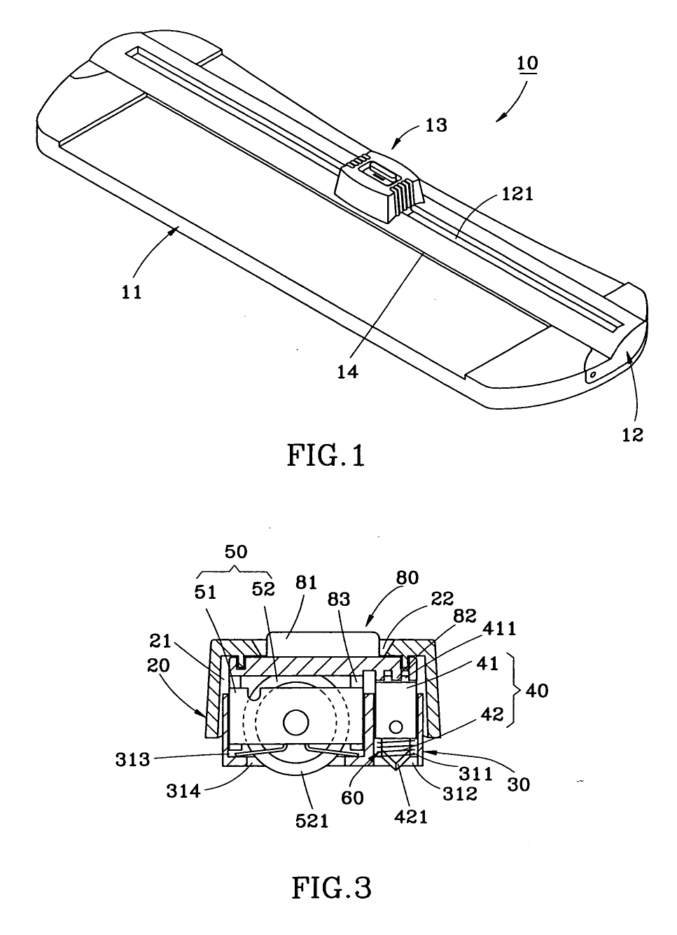

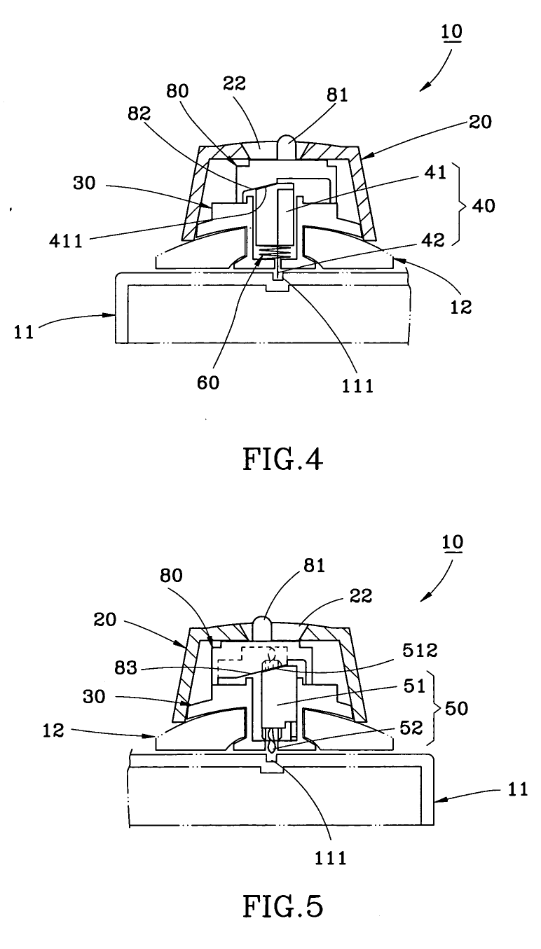

As shown in FIG. 1 to FIG. 4, a paper cutting device of the preferred embodiment of the present invention mainly comprises a board 11, a rail 12 and a cutter assembly 13. The board 11, on which papers (not shown) are put for cutting, has a slot 111 (referring to FIG. 4). The rail 12, which is made of a flexible plastic material in the present invention, has opposite ends mounted on the board 11 and a middle section suspended. A space 14 is defined between the middle section of the rail 12 and the board 11, in which papers are received. The rail 12 has a guiding slot 121 parallel to the slot 111 of the board 11 (referring to FIG. 4). The board 11 and the rail 12 are conventional elements, and I do not describe the detail here. The rail 12 can be printed with scale (not shown) beside the guiding slot 121.

As shown in FIG. 2 to FIG. 7, the cutter assembly 13 has a housing 20, a base 30, a first cutter 40, a second cutter 50, a first elastic member 60, a second elastic member and a switch 80.

The housing 20 has a chamber 21 therein, which is open at a bottom thereof and has a hole 22 at a top thereof.

The base 30 has a body portion 31 to be received in the guiding slot 121 of the rail 12. The body portion 31 has two upper flanges 32 and two lower flanges 33 at opposite lateral sides thereof. The flanges 31 and 32 are located above and below the rail 12 (referring to FIG. 4) to allow the base 30 sliding along the guiding slot 121 but escaping from the rail 12. The body portion 31 has a first slot 311 at a top thereof and a first aperture 312 at a bottom of the first slot 311, which is open at a bottom of the body portion 31. The body portion 31 further has a second slot 313 beside the first slot 311 and a second aperture 314 at a bottom of the second slot 313. Tow screws 34 are inserted into holes on the upper flanges 31 respectively to secure the base 30 to the housing 20, such that the first slot 311 and the second slot 313 of the base 30 are communicated with the chamber 21 of the housing 20, and the housing 20 is moved along with the base 30.

The first cutter 40 has a mount 41 and a cutter 42, wherein the mount 41 is received in the first slot 311 of the base 30 to slide along the first slot 311. The mount 41 has an inclined resting face 411 at a top thereof. The cutter 42 is mounted at a bottom of the mount 41 with a blade 421 thereof extruded out of the base 30 via the first aperture 315.

The second cutter 50 has a mount 51 and a rolling cutter 52, wherein the mount 51 is received in the second slot 313 of the base 30 to slide along the second slot 313. The mount 51 is a U-shaped element having a recess 511 at a top thereof and two inclined resting faces 512 at the top thereof and at opposite sides of the recess 511. The inclined directions of the resting faces 512 is opposite to the resting face 411 of the first cutter 40. The rolling cutter 52 is received in the recess 511 of the mount 51 and pivoted on the mount 51 with a portion thereof beyond the mount 51 and passing through the second aperture 314 of the base 30. The rolling cutter 52 has a waved blade 521 at a periphery thereof.

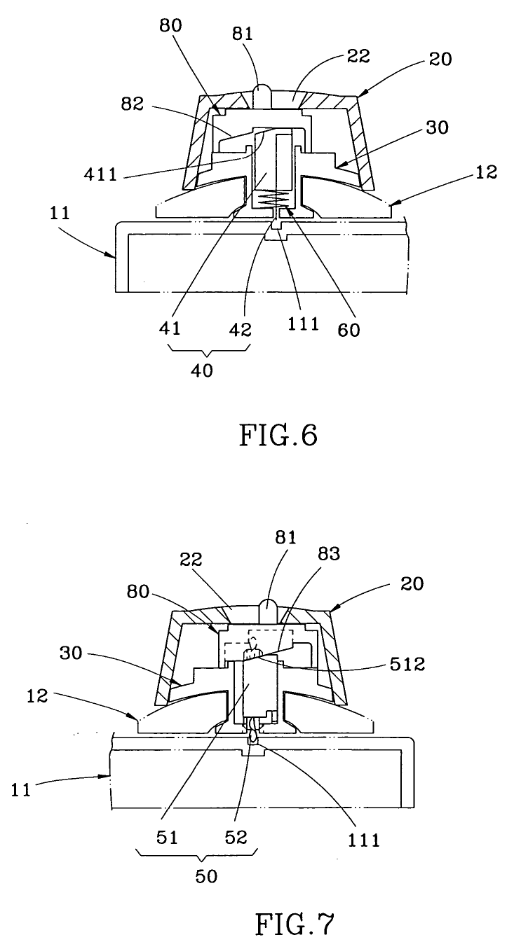

The first elastic member 60, which is a compression spring in the present invention, have opposite ends fitted to the cutter 42 of the first cutter 40 and rested on the mount 41 respectively to move the first cutter 40 upward to a storage position (referring to FIG. 6).

The second elastic member 70 has two elastic plates 71 and 72, each of which has opposite ends mounted on the bottom of the mount 51 and rested on the a sidewall of the second slot 313 of the base 30 to move the mount 51 to a storage position (referring to FIG. 5).

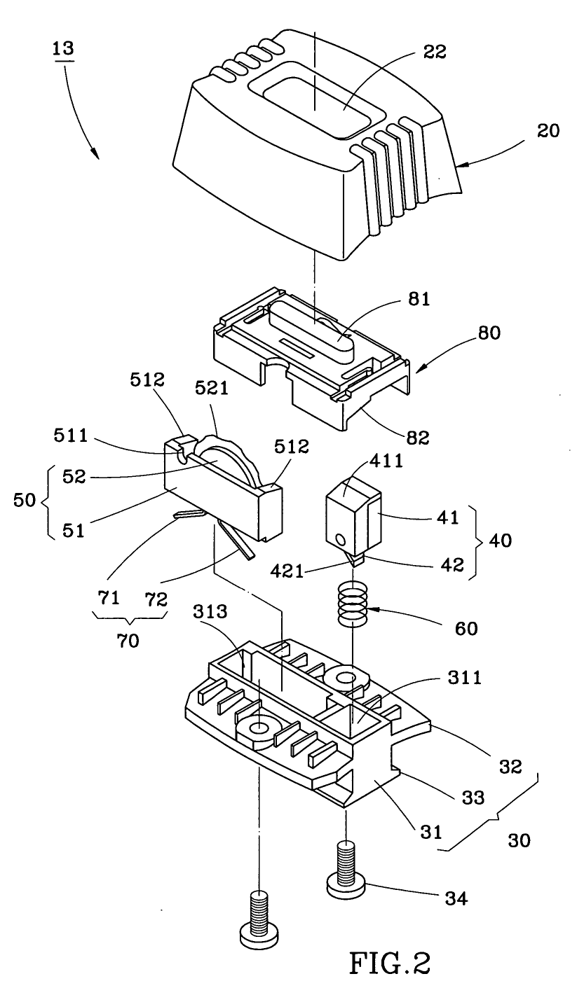

As shown in FIG. 3, the switch 80 is installed in the chamber 21 of the housing 20 to cover the first cutter 40 and the second cutter 50. The housing 20 is moved between a first position (referring to FIG. 4 and FIG. 5) and a second position (referring to FIG. 4 and FIG. 7). The switch 80 has a post 81 at a top thereof extruded out of the housing 10 via the hole 22 of the housing 20 and a first pressing portion 82 and second pressing portion 82 at a bottom thereof. The first pressing portion 82 is associated with the resting face 411 of the first cutter 40, and the second pressing portion 83 is associated with the resting face 512 of the second cutter 50, such that the first cutter 40 is moved by the switch 80 to an extruding position (referring to FIG. 4) while the switch 80 is moved to the first position, and the second cutter 50 is moved by the switch 80 to an extruding position (referring to FIG. 7) while the switch 80 is moved to the second position.

In operation, user has to exert the post 81 to move the switch 80 and to switch the first cutter 40 and second cutter 50 for cutting. When the first cutter 40 is chosen, it cuts the paper with a straight edge, and when the second cutter 50 is chosen, it cuts the paper with a waved edge.

In conclusion, the paper cutting device of the present invention is very convenient to be put on a table for cutting papers. It also can switch various cutters to cut papers, such that it gets various cutting patterns. The rail is made of flexible plastic that the rail is pressed at opposite sides thereof to deform the guiding slot and to assemble and disassemble the base of the cutter assembly.

It has to be mentioned here that the first and second elastic members are to return the cutters, such that any element, such as spring, elastic plate, flexible rubber, serving the same function is the equipollent device.

What is claimed is:

1. A cutter assembly of a paper cutting device, comprising:
a housing having a chamber therein;
a base fixed at a bottom of the housing, which has a first slot and a second slot, and both of the slots are communicated with the chamber of the housing;
a first cutter received in the first slot of the base to be moved between an extruding position and a storage position;
a second cutter received in the second slot of the base to be moved between an extruding position and a storage position, and
a switch received in the chamber of the housing to cover the first cutter and the second cutter, wherein the switch is moved between the a first position, in which the switch moves the first cutter to the extruding position from the storage position, and a second position, in which the switch moves the second cutter to the extruding position from the storage position.

2. The cutter assembly as defined in claim 1, wherein the housing has a hole at a top thereof communicated with the chamber, and the switch has a post extruded out of the housing via the hole.

3. The cutter assembly as defined in claim 2, wherein the first cutter has a mount having at least an inclined resting face and a cutter mounted on the mount, and the second cutter has a mount having at least an inclined resting face and a rolling cutter mounted on the mount, wherein an inclined direction of the resting face of the mount of the first cutter is opposite to that of the resting face of the mount of the second cutter, and the switch has a first pressing portion and a second pressing portion associated with the resting portions of the mounts of the first and second cutters respectively, wherein the first pressing portion of the switch is attached on the resting face of the mount of the first cutter to move the first cutter to the extruding position while the switch is moved to the first position, and the second pressing portion of the switch is attached on the resting face of the mount of the second cutter to move the second cutter to the extruding position while the switch is moved to the second position.

4. The cutter assembly as defined in claim 3, further comprising a first elastic member between the base and of the first cutter to urge the first cutter to the storage position.

5. The cutter assembly as defined in claim 4, wherein the first elastic member is compression spring.

6. The cutter assembly as defined in claim 3, wherein the base has a first aperture at a bottom of the first slot, which is open at a bottom of the base, and the cutter of the first cutter has a blade extruded out of the base via the first aperture.

7. The cutter assembly as defined in claim 3, further comprising a second elastic member between the base and of the second cutter to urge the second cutter to the storage position.

8. The cutter assembly as defined in claim 7, wherein the second elastic member has a plurality of elastic plates having opposite ends rested on the base and the second cutter.

9. The cutter assembly as defined in claim 3, wherein the base has a second aperture at a bottom of the second slot, which is open at a bottom of the base, and the cutter of the second cutter has a blade extruded out of the base via the second aperture.

10. A paper cutting device, comprising:
a board having a rail thereon, and
a cutter assembly provided on the rail for reciprocation, which comprises a housing having a chamber therein; a base fixed at a bottom of the housing, which has a first slot and a second slot, and both of the slots are communicated with the chamber of the housing; a first cutter received in the first slot of the base to be moved between an extruding position and a storage position; a second cutter received in the second slot of the base to be moved between an extruding position and a storage position, and a switch received in the chamber of the housing to cover the first cutter and the second cutter, wherein the switch is moved between the a first position, in which the switch moves the first cutter to the extruding position from the storage position, and a second position, in which the switch moves the second cutter to the extruding position from the storage position.

11. The paper cutting device as defined in claim 10, wherein the rail has a guiding slot, and the base of the cutter assembly, which is engaged with the guiding slot to move along the slot, has flanges at opposite lateral sides located above and below the rail respectively.

12. The paper cutting device as defined in claim 11, wherein the rail is made of a flexible plastic material to be exerted to deform the guiding slot.

13. The paper cutting device as defined in claim 11, wherein the board has a slot under the guiding slot of the rail to receive a blade of the first cutter or the second cutter therein when the first cutter or the second cutter is moved to the extruding position.

14. The paper cutting device as defined in claim 10, wherein the rail has opposite ends mounted on the board and a middle section between the ends suspended from the board, and a space is defined between the middle section of the rail and the board, in which at least a paper is received.
